(19) United States
(12) Patent Application Publication
(10) Pub. No.: US 2022/0128347 A1
(43) Pub. Date: Apr. 28, 2022

(54) SYSTEM AND METHOD TO MEASURE OBJECT DIMENSION USING STEREO VISION

(71) Applicant: KamerAI Private Limited, Chennai (IN)

(72) Inventor: Sowmiya Vohinder, Coimbatore (IN)

(73) Assignee: KamerAI Private Limited

(21) Appl. No.: 17/504,512

(22) Filed: Oct. 19, 2021

(30) Foreign Application Priority Data
Oct. 28, 2020 (IN) 202041047128

(51) Int. Cl. G01B 11/03; G01B 11/02; H04N 13/106; G06T 7/593; G06T 7/62

(52) U.S. Cl. CPC G01B 11/03; G01B 11/028; H04N 2013/0081; G06T 7/593; G06T 7/62; H04N 13/106

(57) ABSTRACT

A system to measure object dimension using stereo vision is disclosed. The system includes a stereo camera, configured to capture a plurality of image frames corresponding to the object. The system includes an image recognition module, configured to detect one or more geometrical shapes of the object from the plurality of captured image frames and also configured to recognize one or more corner points of one or more detected geometrical shape of the object based on the plurality of captured image frames via a computer vision technique. The system includes a coordinate estimation module configured to estimate real-world X-axis, Y-axis and Z-axis coordinate of each of one or more recognized corner points in real time by a stereo triangulation technique. The system includes measuring real-world length, breadth and height of the object in real time by calculating Euclidean distance between estimated real-world X-axis, Y-axis and Z-axis coordinate.

### EARLIEST PRIORITY DATE

This application claims priority from a complete patent application filed in India having Patent Application No. 202041047128, filed on Oct. 28, 2020, and titled “SYSTEM AND METHOD TO MEASURE OBJECT DIMENSION USING STEREO VISION”.

### FIELD OF INVENTION

Embodiments of a present disclosure relates to a dimension measurement method, and more particularly to a system and a method to measure object dimension using stereo vision.

### BACKGROUND

For efficient storing and transporting of any cargo, dimensions of both the cargo and constituent packaging material are analysed or measured. Here, the constituent packaging material may be boxes, crates and other items. After analysis, a position is computed within the package for optimized placement of each cargo item. For economizing on the storage and shipping costs and expenses, rational distribution of the cargo inside a packaging material is very much needed. So, it is important to note that the costs associated with the storage or shipping of the cargo items have a direct and positive correlation with cargo sizes.

To understand measurement information about the cargo, usually any dimensioning system uses stereoscopic imaging. Stereoscopic imaging uses a pair of stereo images of the cargo in order to determine geometric properties or measurement information about the cargo. In many existing measurement systems manual selection of corner points is required to estimate the object dimension, which in turn requires human intervention.

In above stated conventional approach, manual labour interaction is needed every time to understand the measurement information of any cargo. Here, from the captured stereo images, a user has to compute the cargo's length, breadth and height manually by selecting the corner points of the object. Such manual calculation is inefficient as well as inaccurate.

Hence, there is a need for an improved system to measure object dimension using stereo vision without human intervention. A method to operate the same and therefore address the aforementioned issues to measure the cargo, may also be used in other fields rather than packaging industry.

### BRIEF DESCRIPTION

In accordance with one embodiment of the disclosure, a system to measure object dimension using stereo vision is disclosed. The system includes one or more processors hosted on a server. The system includes a stereo camera. The stereo camera is positioned at a predefined height or a predefined distance with respect to the object. The stereo camera is configured to capture a plurality of image frames corresponding to the object.

The system also includes an image recognition module operable by the one or more processors. The image recognition module is configured to detect one or more geometrical shapes of the object from the plurality of captured image frames. The image recognition module is also configured to recognize one or more corner points of one or more detected geometrical shapes of the object.

The system also includes a coordinate estimation module operable by the one or more processors. The coordinate estimation module is operatively coupled to the image recognition module. The coordinate estimation module is configured to estimate real-world X-axis coordinate of each of one or more corner points identified using a stereo triangulation technique in real time. The coordinate estimation module is also configured to estimate real-world Y-axis coordinate of each of the one or more corner points identified using the stereo triangulation technique in real time. The coordinate estimation module is also configured to estimate real-world Z-axis coordinate of each of the one or more corner points identified using the stereo triangulation technique in real time.

The system also includes an object dimension measurement module operable by the one or more processors. The object dimension measurement module is operatively coupled to the coordinate estimation module. The object dimension measurement module is configured to estimate real-world length, breadth and height of the object in real time by calculating Euclidean distance between real-world X-axis coordinate, real-world Y-axis coordinate and real-world Z-axis coordinate of each of the recognized corner points, thereby measuring dimension of the object.

In accordance with one embodiment of the disclosure, a method for measuring object dimension using stereo vision is disclosed. The method includes capturing a plurality of image frames corresponding to the object. The method also includes detecting one or more geometrical shape of the object from the plurality of captured image frames. The method also includes recognizing one or more corner points of one or more detected geometrical shape corresponding to the plurality of captured image frames.

The method also includes estimating real-world X-axis coordinate of each of one or more recognized corner points in real time by a stereo triangulation technique. The method also includes estimating real-world Y-axis coordinate of each of the one or more recognized corner points in real time by the stereo triangulation technique. The method also includes estimating real-world Z-axis coordinate of the each of one or more recognized corner points in real time by the stereo triangulation technique. The method also includes measuring real-world length, breadth and height of the object in real time by calculating Euclidean distance between estimated real-world X-axis coordinate, real-world Y-axis coordinate and real-world Z-axis coordinate of each of the one or more recognized corner points.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of a system to measure object dimension using stereo vision in accordance with an embodiment of the present disclosure;

FIG. 2 is a schematic representation of an embodiment representing the system to measure object dimension using stereo vision of FIG. 1 in accordance with an embodiment of the present disclosure;

FIG. 3 is a schematic representation showcasing the system arrangement for measuring the object dimension using stereo vision of FIG. 1 in accordance with an embodiment of the present disclosure;

FIG. 4 (a) is a schematic representation of a cardboard box being analysed for corner points by the system of FIG. 1 in accordance with an embodiment of the present disclosure;

FIG. 4 (b) is a schematic exemplary representation of the cardboard box being analysed for corner points by the system of FIG. 1 in accordance with an embodiment of the present disclosure;

FIG. 4 (c) is a schematic representation of a polybag being analysed for corner points by the system of FIG. 1 in accordance with an embodiment of the present disclosure;

FIG. 5 is a block diagram of a computer or a server in accordance with an embodiment of the present disclosure; and

FIG. 6 is a flowchart representing the steps of a method for measuring object dimension using stereo vision in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated online platform, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or subsystems or elements or structures or components preceded by “comprises . . . a” does not, without more constraints, preclude the existence of other devices, subsystems, elements, structures, components, additional devices, additional subsystems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system to measure object dimension using stereo vision. The system includes a stereo camera, arranged to capture a plurality of image frames corresponding to the object. The system includes an image recognition module, configured to detect one or more geometrical shapes of the object from the plurality of captured image frames and also configured to recognize one or more corner points of one or more detected geometrical shape of the object based on the plurality of captured image frames via a computer vision technique.

The system includes a coordinate estimation module configured to estimate real-world X-axis, Y-axis and Z-axis coordinate of each of one or more recognized corner points in real time by a stereo triangulation technique. Further, the system is configured to measure real-world length, breadth and height of the object in real time by calculating Euclidean distance between estimated real-world X-axis, Y-axis and Z-axis coordinate.

A computer system (standalone, client or server computer system) configured by an application may constitute a “module’ that is configured and operated to perform certain operations. In one embodiment, the “module’ may be implemented mechanically or electronically, so a module may comprise dedicated circuitry or logic that is permanently configured (within a special-purpose processor) to perform certain operations. In another embodiment, a “module” may also comprise programmable logic or circuitry (as encompassed within a general-purpose processor or other programmable processor) that is temporarily configured by software to perform certain operations.

Accordingly, the term “module’ should be understood to encompass a tangible entity, be that an entity that is physically constructed permanently configured (hardwired) or temporarily configured (programmed) to operate in a certain manner and/or to perform certain operations described herein.

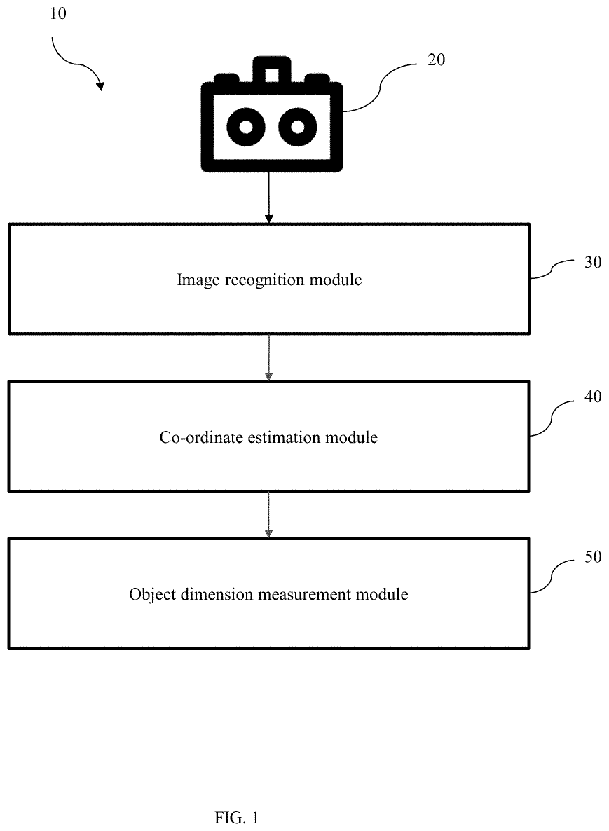

FIG. 1 is a block diagram representation of a system 10F to measure object dimension using stereo vision in accordance with an embodiment of the present disclosure. The system 10 enables easy computation of any cargo or object dimension estimating the real world 3d coordinates using the stereoscopic triangulation procedure for one or more 2d pixel coordinates, that need to be measured. In such computations, the system 10 uses the stereo images to detects the cargo or object presence followed by detecting the points to be measured from the image using the computer vision technique.

The detected 2d pixel points are converted to 3d real world coordinates using the stereoscopic triangulation procedure. The system 10 now enables the calculation of length, breadth, and height of the cargo by applying the Euclidean formula for the estimated 3d real world co-ordinates. Thereby, the system 10 increases logistical efficiency and reduces cost of commerce in relation to storing and transporting of the cargos. In such embodiment, the cargo comprises any shipment of items that needed to be transported or stored.

The system 10 includes one or more processors hosted on a server. In one embodiment, the server comprises a cloud server. The system 10 also includes a stereo camera 20. The stereo camera 20 is positioned at a predefined height and a predefined distance with respect to an object. The stereo camera 20 is configured to capture a plurality of image frames corresponding to the object. It is pertinent to note that the stereo camera 20 which is positioned at a proposed height and proposed distance, adequately captures multiple clear images of the object for further analysis. In such embodiment, the object refers to any cargo.

The system 10 also includes an image recognition module 30 operable by the one or more processors. The image recognition module 30 is configured to detect one or more geometrical shapes of the object from the plurality of captured image frames. In one particular embodiment, if any object is fabricated with multiple geometrical shapes, all such geometrical shapes is detected via the image recognition module 30. In such embodiment, the one or more geometrical shapes may be of cuboidal, cubical, spherical and the like.

In one exemplary embodiment, a particular exemplary object may encompass two geometrical shapes. Top half may be cuboidal and bottom half may be spherical. The system 10 via the image recognition module 30 detects specific two geometrical shape for further analysis.

The image recognition module 30 is also configured to recognize one or more corner points of one or more detected geometrical shape of the object based on the plurality of captured image frames via a computer vision technique. In one exemplary embodiment, the image recognition module 30 may recognize pixel points to measure for a cuboidal shaped object, pixel points to measure for the cubical shaped objects and the like. In such embodiment, the corner points may be of left image as well as right image corresponding to the multiple images as captured by stereo camera 20. Automatic right corner points and left corner points may be detected.

In such embodiment, the computer vision technique recognises each of the one or more corner points based on difference in brightness of a plurality of segments of each of the plurality of captured image frames in real time. As used herein, the term “computer vision” refers to an interdisciplinary scientific field that deals with how computers or processors may gain high-level understanding from digital images or videos.

In the above stated exemplary embodiment, for top half cuboidal shape, the image recognition module 30 via the computer vision technique attempts to detect top and side corner points of the cuboid edges. Similarly, for bottom half spherical shape, the image recognition module 30 via the computer vision technique attempts to detect diameter end points of the spherical body as captured.

The system 10 also includes a coordinate estimation module 40 operable by the one or more processors. The coordinate estimation module 40 is operatively coupled to the image recognition module 30. The coordinate estimation module 40 is configured to estimate real-world X-axis coordinate of each of one or more recognized corner points in real time by a stereo triangulation technique. The coordinate estimation module 40 is also configured to estimate real-world Y-axis coordinate of each of the one or more recognized corner points in real time by the stereo triangulation technique. The coordinate estimation module 40 is also configured to estimate real-world z-axis coordinate of each of the one or more recognized corner points in real time by the stereo triangulation technique. As used herein, the term “coordinate system” is a system that uses one or more numbers, or coordinates, to uniquely determine the position of points or other geometric elements on a manifold such as Euclidean space.

It is pertinent to note that, the computer vision technique is used for identifying the corner point in 2d image. The stereoscopic triangulation procedure is used to estimate the 3d real world coordinates for 2d corner points.

Via the coordinate estimation module 40, corner points of any geometrical shaped object are estimated, thereby calculating real-world X-axis coordinate, real-world Y-axis coordinate and real-world Z-axis coordinate. Stereoscopic triangulation technique is being used by the coordinate estimation module 40 to estimate the 3d-coordinates of any 2d corner point. In such embodiment, via the stereoscopic triangulation technique the coordinate estimation module 40 estimates the parameters such as corner point in captured left image of the detected geometrical body, corner point in captured right image of the detected geometrical body, central breadth of the detected geometrical body and the like. Basically, triangulation in stereo analysis is the task of computing the 3D position of points in the images, given the disparity map and the geometry of the stereo setting.

In one embodiment, the real-world X-axis coordinate, the real-world Y-axis coordinate and the real-world Z-axis coordinate are estimated based on pre-defined focal length of the stereo camera and pre-defined baseline distance of the stereo camera 20 lenses. In such embodiment, the pre-defined baseline distance of stereo camera 20 lenses comprises the fixed distance between the two lenses corresponding the stereo camera 20.

In one specific embodiment, the following formulas is used for estimating the real-world X-axis coordinate, the real-world Y-axis coordinate and the real-world Z-axis coordinate.

Z=(F×B)/(x_{L}−x_{R})

X=((x_{L}−cₓ)×Z)/F

Y=((y_{L}−c_{Y})×Z)/F

In the above stated formula, x_{L} and y_{L} represents corner point in left image. x_{R} and y_{R} represents corner point in right image. c_{X} represents image centre breadth and c_{Y} represents image centre height. F represents the focal length of the stereo camera 20 in pixel. B represents baseline distance between the two lenses in the stereo camera 20.

The system 10 also includes an object dimension measurement module 50 operable by the one or more processors. The object dimension measurement module 50 is operatively coupled to the coordinate estimation module 40. The object dimension measurement module 50 is configured to estimate real-world length, breadth and height of the object in real time from estimated real-world X-axis coordinate, real-world Y-axis coordinate and real-world Z-axis coordinate of each of the one or more recognized corner points. Here, measurement of the length, the breadth and the height are based on Euclidean distance formula. The Euclidean distance formula between two coordinates (x₁, y₁, z₁ and x₂, y₂, z₂) is

Measure=\sqrt{(x₂−x₁)²+(y₂−y₁)²+(z₂−z₁)²}

Furthermore, the system 10 also includes an object volume estimation module operable by the one or more processors. The object volume estimation module is operatively coupled to the object dimension measurement module 50. The object volume estimation module is configured to estimate volume of the object based on measured length, measured breadth and measured height. In one embodiment, the estimated volume of the object is calculated on the basis of the one or more detected geometrical shape. For calculation of volume of different geometrical shaped body, a corresponding different formula is used every time.

Moreover, the system 10 also includes a dimension notification module operable by the one or more processors. The dimension notification module is operatively coupled to the object dimension measurement module 50. The dimension notification module is configured to notify at least one of the estimated real-world length, breadth, height, and volume of the object by a plurality of notifying means. In one embodiment, the plurality of notifying means may include message, electronic mail and the like.

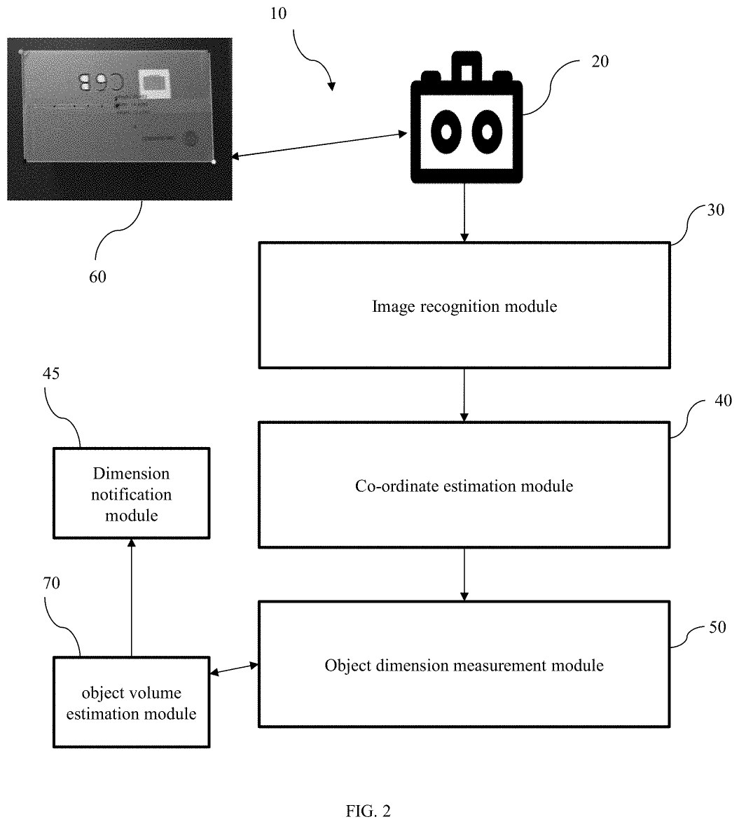

FIG. 2 is a schematic representation of an embodiment representing the system 10 to measure object dimension using stereo vision of FIG. 1 in accordance with an embodiment of the present disclosure. The system 10 is being used in this exemplary embodiment to understand the packaging material dimension for the Cardboard box A 60. At first the Cardboard box A 60 is positioned at a pre-defined distance from a stereo camera X 20. Here, the stereo camera X 20 is positioned at particular distance to capture clear image frames of the Cardboard box A 60. The stereo camera 20 the right and left captures images of the Cardboard box A 60 from top view angle.

An image recognition module 30 at first detects geometrical shape of the Cardboard box A 60 from the images obtained through stereo camera. The associated geometrical shape may be cuboidal. Additionally, the image recognition module 30 also recognizes one or more corner points of the detected geometrical shape of the Cardboard box A 60 based on the stereo pair image frames via a computer vision technique. Here, specifically the image recognition module 30 detects corner points of the Cardboard box A 60 by understanding the difference in brightness of a plurality of segments of each of the multiple captured image frames in real time. Each segment comprising a corner edge or point will have different brightness level.

The system 10 via a coordinate estimation module 40 estimates real-world X-axis, real-world Y-axis and real-world Z-axis coordinate of each of the recognized corner points of the Cardboard box A 60. For such calculation, the coordinate estimation module 40 uses stereoscopic triangulation technique and mathematical formulas. The coordinate estimation module 40 uses three formulas for calculation of 3-dimension coordinates of any recognized 2d corner point.

Z=(F×B)/(x_{L}−x_{R})

X=((x_{L}−cₓ)×Z)/F

Y=((y_{L}−c_{Y})×Z)/F

F represents focal length of the camera in pixel. B represents baseline distance between the two lenses in stereo camera 20. Parameters such as x_{L}, y_{L}, x_{R}, y_{R}, c_{X} and c_{Y} are calculated with help of computer vision technique from each of the recognized corner points of the image frames. In above stated formulas, x_{L} and y_{L} represents corner point in left image. x_{R} and y_{R} represents corner point in right image. c_{X} represents image centre breadth and c_{Y} represents image centre height.

In such exemplary embodiment, for calculation of the real dimension of the Cardboard box A 60, the system 10 specifically uses an object dimension measurement module 50. The object dimension measurement module 50 via the Euclidean formula calculates the dimensions height of the Cardboard box A 60. For example, the detected corner coordinate point of the Cardboard box 60 top end is (X₁, Y₁, Z₁) and bottom end is (X₂, Y₂, Z₂). The dimension may easily be calculated between them by the formula:

Measure=\sqrt{(x₂−x₁)²+(y₂−y₁)²+(z₂−z₁)²}

It is pertinent to note that is similar fashion, the object dimension measurement module 50 may be able to calculate breadth and length of the Cardboard box A 60. Furthermore, the object volume estimation module 70 is configured to estimate volume of the object based on measured length, measured breadth and measured height. The estimated volume of the Cardboard box A 60 is calculated on the basis of the earlier detected geometrical shape of the Cardboard box A 60.

All such estimation of length, breadth, height and volume enable the user to understand the packaging material dimension required for the Cardboard box A 60. All such estimation and calculation may easily be notified to the user via the dimension notification module 45.

The image recognition module 30, the coordinate estimation module 40 and the object dimension measurement module 50 in FIG. 2 is substantially equivalent to the image recognition module 30, the coordinate estimation module 40 and the object dimension measurement module 50 of FIG. 1.

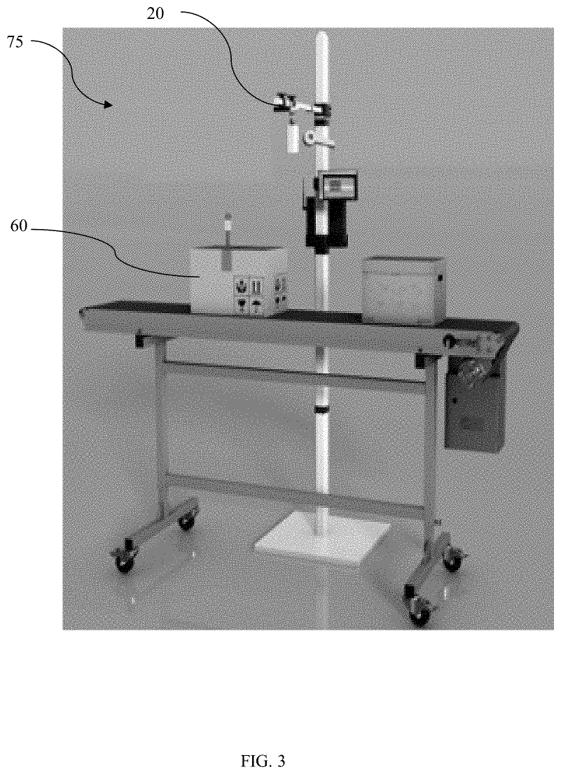

FIG. 3 is a schematic representation showcasing the system arrangement for measuring the object dimension using stereo vision camera 75 of FIG. 1 in accordance with an embodiment of the present disclosure. In the stated arrangement, the cardboard box 60 is positioned below a stereo camera 20. Through the camera 20, the system 75 analyses the corner points of the cardboard box 60. Further, the system 10 calculates the volume occupied by the cardboard box 60.

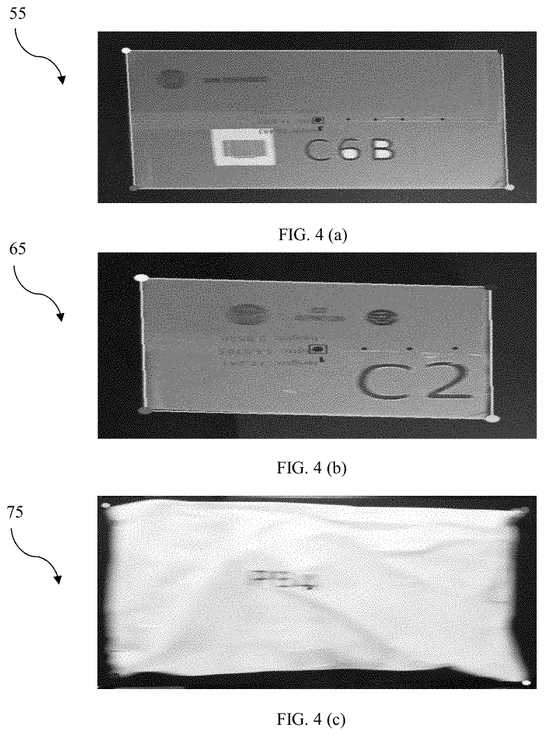

FIG. 4 (a) is a schematic representation of a cardboard box 55 being analysed for corner points by the system of FIG. 1 in accordance with an embodiment of the present disclosure. The system 10 enables measurement of corner points of the cardboard box. Simultaneously, the system measures the length, width and height.

FIG. 4 (b) is a schematic exemplary representation of the cardboard box 65 being analysed for corner points by the system of FIG. 1 in accordance with an embodiment of the present disclosure. The system 10 enables measurement of corner points and volume of the cardboard box. Simultaneously, the system 10 measures the length, width and height. In one embodiment, the height of the box is of 5.8526 cm, the length of the box is of 17.241 cm and the width of the box is of 13.5793 cm.

FIG. 4 (c) is a schematic representation of a polybag 75 being analysed for corner points by the system of FIG. 1 in accordance with an embodiment of the present disclosure. The system 10 enables measurement of corner points of the shown polybag. Simultaneously, the system measures the length, width and height of the shown polybag. The system 10 clearly shows detected corner points of the polybag.

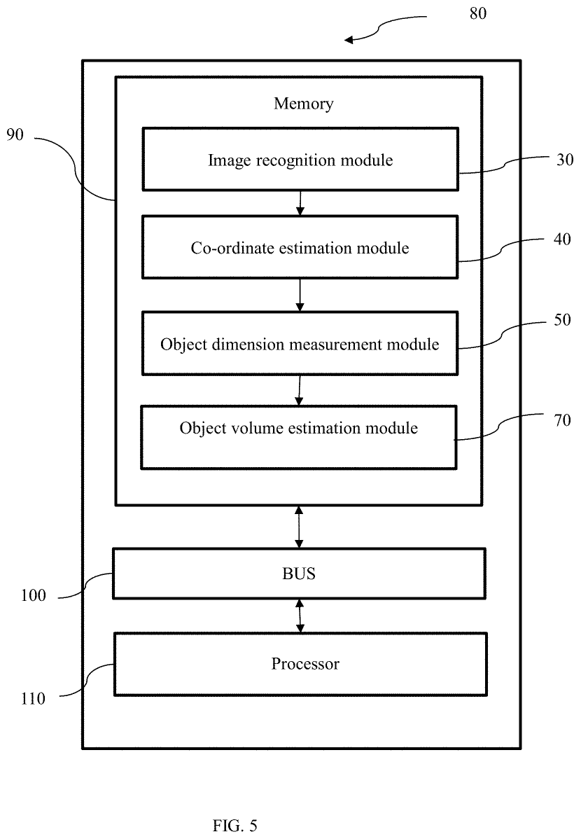

FIG. 5 is a block diagram of a computer or a server 80 in accordance with an embodiment of the present disclosure. The server 80 includes processor(s) 110, and memory 90 coupled to the processor(s) 110.

The processor(s) 10, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 90 includes a plurality of modules stored in the form of executable program which instructs the processor 110 via a bus 100 to perform the method steps illustrated in FIG. 1. The memory 90 has following modules: the image recognition module 30, the coordinate estimation module 40 and the object dimension measurement module 50.

The image recognition module 30 is configured to detect one or more geometrical shapes of the object from the plurality of captured image frames. The image recognition module 30 is also configured to recognize one or more corner points of one or more detected geometrical shape of the object based on the plurality of captured image frames via a computer vision technique.

The coordinate estimation module 40 is configured to estimate real-world X-axis coordinate of each of one or more recognized corner points in real time. The coordinate estimation module 40 is also configured to estimate real-world Y-axis coordinate of each of the one or more recognized corner points in real time. The coordinate estimation module 40 is also configured to estimate real-world Z-axis coordinate of each of the one or more recognized corner points in real time.

The object dimension measurement module 50 is configured to measure length, breadth and height of the object in real time from estimated real-world X-axis coordinate, real-world Y-axis coordinate and real-world Z-axis coordinate of each of the one or more recognized corner points.

Computer memory elements may include any suitable memory device(s) for storing data and executable program, such as read only memory, random access memory, erasable programmable read only memory, electrically erasable programmable read only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. Executable program stored on any of the above-mentioned storage media may be executable by the processor(s) 110.

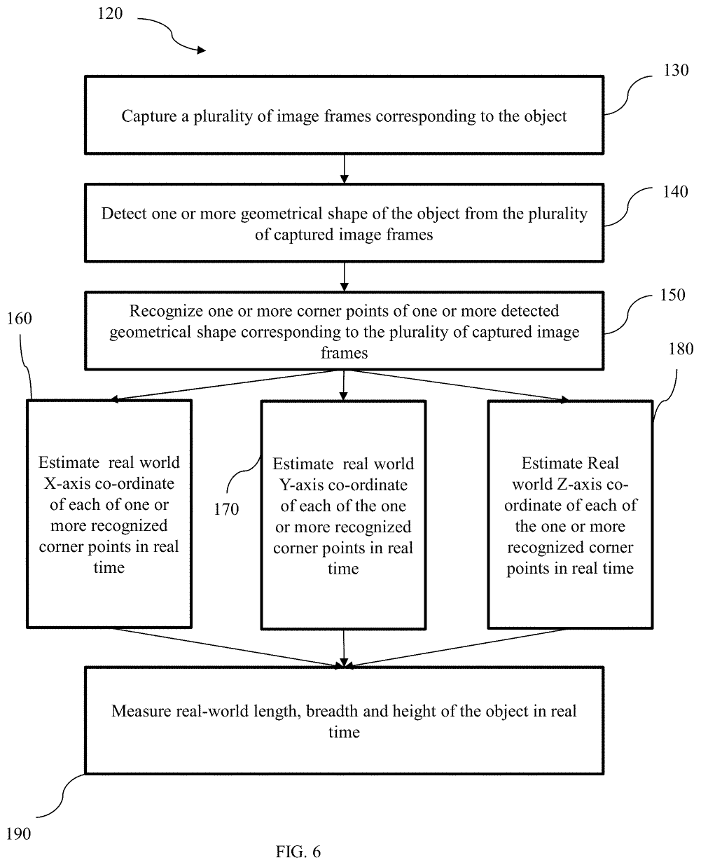

FIG. 6 is a flowchart representing the steps of a method 120 for measuring object dimension using stereo vision in accordance with an embodiment of the present disclosure. The method 120 includes capturing a plurality of image frames corresponding to the object in step 130. In one embodiment, capturing the plurality of image frames corresponding to the object includes capturing the plurality of image frames corresponding to the object by a stereo camera.

The method 120 also includes detecting one or more geometrical shape of the object from the plurality of captured image frames in step 140. In one embodiment, detecting the one or more geometrical shape of the object from the plurality of captured image frames includes detecting the one or more geometrical shape of the object from the plurality of captured image frames by an image recognition module.

The method 120 also includes recognizing one or more corner points of one or more detected geometrical shape corresponding to the plurality of captured image frames via a computer vision technique in step 150. In one embodiment, recognizing the one or more corner points of the one or more detected geometrical shape corresponding to the plurality of captured image frames via the computer vision technique includes recognizing the one or more corner points of the one or more detected geometrical shape corresponding to the plurality of captured image frames by the image recognition module.

In another embodiment, recognizing the one or more corner points of the one or more detected geometrical shape corresponding to the plurality of captured image frames via the computer vision technique includes recognizing the one or more corner points of the one or more detected geometrical shape comprises recognition based on difference in brightness of a plurality of segments of each of the plurality of captured image frames in real time.

The method 120 also includes estimating real-world X-axis coordinate of each of one or more recognized corner points in real time by a stereo triangulation technique in step 160. In one embodiment, estimating the real-world X-axis coordinate of each of the one or more recognized corner points in real includes estimating the real-world X-axis coordinate of each of the one or more recognized corner points in real time by a coordinate estimation module.

The method 120 also includes estimating real-world Y-axis coordinate of each of the one or more recognized corner points in real time by the stereo triangulation technique in step 170. In one embodiment, estimating the real-world Y-axis coordinate of each of the one or more recognized corner points in real time includes estimating the real-world Y-axis coordinate of each of the one or more recognized corner points in real time by the coordinate estimation module.

The method 120 also includes estimating real-world Z-axis coordinate of each of the one or more recognized corner points in real time by the stereo triangulation technique in step 180. In one embodiment, estimating the real-world Z-axis coordinate of each of the one or more recognized corner points in real time includes estimating the real-world Z-axis coordinate of each of one or more recognized corner points in real time by the coordinate estimation module. In another embodiment, estimating the real-world X-axis coordinate, the real-world Y-axis coordinate and the real-world Z-axis coordinate comprises estimating based on pre-defined focal length of the stereo camera and pre-defined baseline distance of stereo camera lenses.

The method 120 also includes measuring real-world length, breadth and height of the object in real time by calculating Euclidean distance between from estimated real-world X-axis coordinate, real-world Y-axis coordinate and real-world Z-axis coordinate of each of the one or more recognized corner points in step 190. In one embodiment, measuring the real-world length, breadth and height of the object in real time by calculating Euclidean distance between from the estimated real-world X-axis coordinate, real-world Y-axis coordinate and real-world Z-axis coordinate of each of the one or more recognized corner points includes measuring the real-world length, the breadth and the height by an object dimension measurement module.

The method 120 also includes estimating volume of the object based on measured real-world length, measured breadth and measured height. In one embodiment, estimating the volume of the object based on the real-world measured length, measured breadth and measured height includes estimating the volume of the object based on measured length, measured breadth and measured height by an object volume estimation module. In another embodiment, estimating the volume of the object based on the real-world measured length, measured breadth and measured height includes estimating the volume of the object comprises estimating on the basis of the one or more detected geometrical shape.

The method 120 also includes notifying at least one of the measured length, breadth, height, and volume of the object by a plurality of notifying means. In one embodiment, notifying at least one of the measured length, breadth, height, and volume of the object by the plurality of notifying means includes notifying at least one of the measured length, breadth, height, and volume of the object by a dimension notification module.

Present disclosure of a system to measure object dimension provides an efficient and accurate dimension measuring procedure. Here, the system basically uses computer vision technique to automatically understand the corner points of any object without any manual interference. Furthermore, the system easily applies the computer vision technique and different formulas for estimating real-world X-axis coordinate, real-world Y-axis coordinate and real-world Z-axis coordinate of the recognised corner point, thereby removing input of any extra manual labour.

The system provides automatic measuring technology for packages of all dimensions from a size of 5 cm (2 in) to 100 cm (39 in). The system may be implemented for objects in static mode and objects in motion at variable speed. The Stereo camera is placed at predefined height. In static mode the object to measure is stationary placed below the stereo camera. The dimension system is also extended to measure objects that are moving on a conveyor at variable speed. Thus, enabling capacity to handle more packages, serve more customers and thereby reduce labour cost.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system to measure object dimension using stereo vision, the system comprises:
one or more processors hosted on a server;
a stereo camera positioned at a predefined height and a predefined distance with respect to the object, and configured to capture a plurality of image frames corresponding to the object;
an image recognition module operable by the one or more processors, wherein the image recognition module is configured to:
detect one or more geometrical shapes of the object from the plurality of captured image frames; and
recognize one or more corner points of one or more detected geometrical shapes of the object via a computer vision technique, wherein the computer vision technique recognises each of the one or more corner points based on difference in brightness of a plurality of segments of each of the plurality of captured image frames in real time;
a coordinate estimation module operable by the one or more processors, and operatively coupled to the image recognition module, wherein the coordinate estimation module is configured to:
estimate real-world X-axis coordinate of each of one or more recognized corner points in real time by a stereo triangulation technique;
estimate real-world Y-axis coordinate of each of the one or more recognized corner points in real time by the stereo triangulation technique; and
estimate real-world Z-axis coordinate of each of the one or more recognized corner points in real time by the stereo triangulation technique; and
an object dimension measurement module operable by the one or more processors, and operatively coupled to the coordinate estimation module, wherein the object dimension measurement module is configured to estimate real-world length, breadth and height of the object in real time by calculating Euclidean distance between real-world X-axis coordinate, real-world Y-axis coordinate and real-world Z-axis coordinate of each of the one or more recognized corner points, thereby measuring dimension of the object.

2. The system as claimed in claim 1, comprising an object volume estimation module operable by the one or more processors, and operatively coupled to the object dimension measurement module, wherein the object volume estimation module is configured to estimate volume of the object based on estimated length, estimated breadth and estimated height, wherein the estimated volume of the object is calculated on the basis of the one or more detected geometrical shape.

3. The system as claimed in claim 1, comprising a dimension notification module operable by the one or more processors, and operatively coupled to the object dimension measurement module, wherein the dimension notification module is configured to notify at least one of the measured length, breadth, height, and volume of the object by a plurality of notifying means.

4. The system as claimed in claim 1, wherein the real-world X-axis coordinate, the real-world Y-axis coordinate and the real-world Z-axis coordinate are estimated based on pre-defined focal length of the stereo camera and pre-defined baseline distance of stereo camera lenses, wherein the pre-defined baseline distance of stereo camera lenses comprises the fixed distance between the two lenses corresponding the stereo camera.

5. A method for measuring object dimension using stereo vision, the method comprising:
capturing, by a stereo camera, a plurality of image frames corresponding to the object;
detecting, by an image recognition module, one or more geometrical shape of the object from the plurality of captured image frames;
recognizing, by the image recognition module, one or more corner points of one or more detected geometrical shape corresponding to the plurality of captured image frames via a computer vision technique;
estimating, by a coordinate estimation module, real-world X-axis coordinate of each of one or more recognized corner points in real time by a stereo triangulation technique;
estimating, by the coordinate estimation module, real-world Y-axis coordinate of each of the one or more recognized corner points in real time by the stereo triangulation technique;
estimating, by the coordinate estimation module, real-world Z-axis coordinate of each of the one or more recognized corner points in real time by the stereo triangulation technique; and
measuring, by an object dimension measurement module, real-world length, breadth and height of the object in real time by calculating Euclidean distance between estimated real-world X-axis coordinate, real-world Y-axis coordinate and real-world Z-axis coordinate of each of the one or more recognized corner points.

6. The method as claimed in claim 5, wherein recognizing, by the image recognition module, the one or more corner points of the one or more detected geometrical shape comprises recognition based on difference in brightness of a plurality of segments of each of the plurality of captured image frames in real time.

7. The method as claimed in claim 5, comprising estimating, by an object volume estimation module, volume of the object based on real-world measured length, measured breadth and measured height.

8. The method as claimed in claim 7, wherein estimating, by the object volume estimation module, the volume of the object comprises estimating on the basis of the one or more detected geometrical shape.

9. The method as claimed in claim 5, comprising notifying, by a dimension notification module, at least one of the estimated real-time length, breadth, height, and volume of the object by a plurality of notifying means.

10. The method as claimed in claim 5, wherein estimating, by the coordinate estimation module, the real-world X-axis coordinate, the real-world Y-axis coordinate and the real-world Z-axis coordinate comprises estimating based on pre-defined focal length of the stereo camera and pre-defined baseline distance of stereo camera lenses.
